(19) United States
(12) Patent Application Publication
(10) Pub. No.: US 2024/0402359 A1
(43) Pub. Date: Dec. 5, 2024

(54) System, Method, and Software for Controlling a Driver Assistance Function

(71) Applicant: Bayerische Motoren Werke Aktiengesellschaft, Muenchen (DE)

(72) Inventor: Victoria KROPP, Muenchen (DE)

(21) Appl. No.: 18/700,379

(22) PCT Filed: Sep. 20, 2022
(86) PCT No.: PCT/EP2022/076071

§ 371 Date: Apr. 11, 2024

(30) Foreign Application Priority Data
Oct. 14, 2021 (DE) 10 2021 126 714.5

(51) Int. Cl. G01S 19/39

(52) U.S. Cl. CPC G01S 19/396

(57) ABSTRACT

Systems, methods, and apparatuses are provided for controlling a driving assistance function. A GNSS receiver module is configured to receive GNSS signals provide information relating to a quality of currently available GNSS signals. An assessment module is configured to use a lookup table to determine, based on the information provided, a signal integrity status which relates to the usability of the currently available GNSS signals for controlling the driving assistance function. A control module is configured to control the driving assistance function based on the signal integrity status of the currently available GNSS signals.

### BACKGROUND AND SUMMARY

The present subject matter relates to a system and a method for controlling a driving assistance function of a vehicle. The present subject matter also relates to software having program code for carrying out such a method when the software runs on a software-controlled processing device.

The present subject matter can be used, in particular, within the framework of a driving assistance system, wherein the longitudinal and/or lateral guidance of the vehicle is controlled in such a manner that a driving task specified by the driving assistance system is performed. In this case, the driving assistance system may enable at least partially automated driving, possibly through to fully automated driving.

Within the scope of the document, the term “automated driving” is understood as meaning driving with automated longitudinal and/or lateral guidance. Automated driving can involve for example driving for a relatively long time on the interstate or in urban surroundings or driving for a limited time in the context of parking. The term “automated driving” encompasses automated driving with an arbitrary degree of automation. Example degrees of automation are assisted, partially automated, highly automated, fully automated and autonomous driving (each with an increasing degree of automation). The five degrees of automation mentioned above correspond to SAE levels 1 to 5 of the SAE J3016 standard (SAE—Society of Automotive Engineering). In the case of assisted driving (SAE level 1), the system performs the longitudinal or lateral guidance in certain driving situations. In the case of partially automated driving (SAE level 2), the system undertakes the longitudinal and lateral guidance in certain driving situations, but the driver needs to monitor the system on an ongoing basis as in the case of assisted driving. In the case of highly automated driving (SAE level 3), the system undertakes the longitudinal and lateral guidance in certain driving situations without the driver needing to monitor the system on an ongoing basis; however, the driver must be capable of taking over the vehicle guidance at the request of the system within a certain time. In the case of fully automated driving (SAE level 4), the system undertakes the vehicle guidance in certain driving situations, even if the driver does not react to a request to intervene, with the result that the driver is dispensed with as a fallback level. In the case of autonomous driving (SAE level 5), the system can perform all aspects of the dynamic driving task under any road and environmental conditions that are also mastered by a human driver. SAE level 5 therefore corresponds to driverless driving, in which the system can automatically cope with all situations during the entire journey in the same way as a human driver; a driver is generally no longer needed.

Some driving assistance functions require knowledge of a precise position of the vehicle. The position can be determined in the longitudinal and/or transverse direction and can be expressed with respect to a predetermined reference point. A relative position of the vehicle can be indicated, for example, in the transverse direction with respect to an identified lane marking. An absolute geographical position can be determined, for example, on the basis of map information relating to a predetermined geodetic reference systems such as WGS84.

The determination of the position of the vehicle is usually subject to a number of errors and inaccuracies. Sensors provide, for example, noisy and/or distorted information or may occasionally fail entirely. Different measurement conditions or complex processing heuristics lead to determinations of different accuracy or reliability.

In order to make it possible to determine the position of the vehicle as accurately and reliably as possible, a plurality of preferably statistically independent sources of position information can be used to statistically estimate the vehicle position. The various items of position information may be based, for example, on camera-based capture of lane boundaries, on lidar-based capture of objects, on an odometry-based prediction and/or on a global navigation satellite system (GNSS), for example GPS, GLONASS, Galileo or Beidou. The plurality of items of position information from the different sources can then be combined to form an estimated vehicle position. In this case, it is possible to resort to common sensor data fusion algorithms, for example Kalman filter techniques.

If GNSS-based position information is used to control a driving assistance function, it should be noted that the satellite signals arriving at a GNSS receiver of the vehicle generally experience degradation as a result of different environmental effects, for example interference. Error sources such as multipath propagation and ionospheric disturbances greatly influence the usability of the GNSS signals and therefore reduce the availability and accuracy of the GNSS-based position information. In addition, components which are used to determine and calculate the vehicle position, for example a GNSS receiver and inertial sensors, can constitute additional error sources. As a result, the availability of the driving assistance function can be restricted by such error influences when determining the vehicle position.

On the basis of this, an object of the present subject matter is to provide improved control of a driving assistance function on the basis of GNSS signals.

The object is achieved by means of a system and a method according to the independent patent claims. Advantageous examples are specified in the dependent claims.

It is pointed out that additional features of a patent claim dependent on an independent patent claim, without the features of the independent patent claim or only in combination with a subset of the features of the independent patent claim, can form a separate invention that is independent of the combination of all of the features of the independent patent claim and can be turned into the subject matter of an independent patent claim, a divisional application or a subsequent application. This applies in the same way to technical teachings that are explained in the description and can form an invention independent of the features of the independent patent claims.

A first aspect of the present subject matter relates to a system for controlling a driving assistance function.

The system may be, in particular, a driving assistance system of a vehicle, in particular a motor vehicle, or a subsystem of such a driving assistance system. In this case, the term “motor vehicle” is intended to be understood as meaning, in particular, a land vehicle which is moved by machine power without being bound to tracks. In this sense, a motor vehicle may be in the form of an automobile, a motorcycle or a tractor, for example.

The driving assistance function may be performed, in particular, during at least partially automated driving of the vehicle. For example, it may be an ACC function (that is to say combined speed and distance control), a steering and lane guidance assistant, a lane change assistance function, a parking assistance function or the like.

The system comprises: a GNSS receiver module which is configured to receive GNSS signals and to provide information relating to a quality of the currently available GNSS signals; an assessment module which is configured to use a lookup table to determine, on the basis of the information provided, a signal integrity status which relates to the usability of the currently available GNSS signals for controlling the driving assistance function; and a control module which is configured to control the driving assistance function on the basis of the signal integrity status of the currently available GNSS signals and/or to use the currently available GNSS signals to control the driving assistance function on the basis of the signal integrity status (that is to say, under certain circumstances, to also decide, on the basis of the signal integrity status, not to use the currently available GNSS signals to control the driving assistance function). In this case, the system may also comprise, for example, a positioning module which is configured to determine, on the basis of the information provided from the GNSS receiver module and the signal integrity status, a highly accurate position solution, on the basis of which the control module controls the driving assistance function. In this case, the availability of the highly accurate position solution can be increased further, for example, by additionally using data from inertial sensors and/or from measured wheel revolutions.

The GNSS receiver module may be configured to determine the information relating to the quality of the currently available GNSS signals on the basis of the received GNSS signals and to then make the information available to the assessment module. The GNSS receiver module may have one or more (data) processing devices which are programmed to perform calculations for determining such information. Furthermore, it is also conceivable for the GNSS receiver module to be configured to carry out dedicated measurements of suitable observables for determining the information relating to the quality of the currently available GNSS signals.

The assessment module may likewise comprise one or more processing devices which are programmed to determine the signal integrity status on the basis of the information provided by the GNSS receiver module. In this case, it is also possible for the assessment module to be completely or partially integrated in the GNSS receiver module; functions of the GNSS receiver module and of the assessment module can therefore be performed using the same processing device(s) in some conceivable examples. It is also possible for functions of the positioning module mentioned above to be completely or partially performed using the same processing devices as are used for functions of the assessment module. It is also conceivable in this case, for example, for the assessment module to form part of the positioning module or for the assessment module and possibly the positioning module to form parts of the control module or for one or more processing device(s) shared by the modules mentioned to be provided.

The assessment module may also have a data memory or may be configured to access a data memory, wherein the lookup table that is used by the assessment module to determine the signal integrity status is stored in the data memory. In this case, the lookup table may contain, in accordance with a predefined metric, an assignment between specific variables associated with the quality of the currently available GNSS signals, as are provided by the GNSS receiver module, and the signal integrity status which relates to the usability of the currently available GNSS signals (in particular with regard to their availability, accuracy and/or reliability). In this case, the assignment can specifically relate to the driving assistance function under consideration. It is also possible to define a plurality of different assignments each relating to a specific driving assistance function in accordance with its requirements in terms of the availability, accuracy and/or reliability of the GNSS signals. If the driving assistance function under consideration is a steering and lane guidance assistant, for example, the lookup table may contain, for example, an assignment which has been determined on the basis of accuracy requirements of the steering and lane guidance assistant in terms of specific variables derived from the GNSS signals, for instance an accuracy requirement in terms of horizontal position determination.

The lookup table and the assignment contained in the latter may be at least partially based on statistical relationships, for example, which have been empirically determined and/or verified on the basis of simulations and/or test drives.

According to one example, the determination of the signal integrity status by means of the assessment module comprises comparing a plurality of signal quality indicators contained in the information provided and/or derived therefrom with respective threshold values stored in the lookup table. In this case, the signal quality indicators may comprise at least two, preferably at least three, and particularly preferably all, of the following variables:
a number of currently available GNSS satellites, that is to say the number of satellites from which the GNSS receiver module can currently receive signals that can be used to determine the position;
a horizontal and/or vertical reduction in the accuracy (dilution of precision-DoP) which results, in particular, from the positions of the currently available GNSS satellites relative to one another and relative to the GNSS receiver module;
code noise which occurs at the GNSS receiver module, preferably in the form of a weighted average of code noise values for all available satellites, wherein the weighting can be carried out during averaging, for example on the basis of the respective satellite elevation;
phase noise which occurs at the GNSS receiver module, preferably in the form of a weighted average of phase noise values for all available satellites, wherein the weighting can be carried out during averaging, for example on the basis of the respective satellite elevation;
a phase tracking loss; this may relate to a correlation between observables and may be stated, for example, in the form of a number of possible cycle slips within a defined time window, in particular as a sum of a standardized number of cycle slips of all simultaneously used satellites within a defined time window;
an interference indicator which indicates a degree of multipath interference and/or unintentional interference.

In this context, a cycle slip may be understood as meaning, for example, in particular a loss or an error during phase tracking as part of a carrier phase measurement. Such cycle slips generally play a role, in particular, outside urban surroundings. In urban surroundings, the number of cycle slips is less relevant owing to the higher signal interference, since the requirements in terms of the accuracy of the GNSS-based position information are lower.

A further possible variable which can be used as a signal quality indicator is an outage time. This can be understood as meaning the time which has elapsed since the beginning of a GNSS outage, wherein the GNSS outage may be due, in particular, to the fact that a required minimum number of satellites that can be used to determine the position is not available. In this context, it is possible to consider, for example, in particular a period of time which indicates how much time has elapsed since a last available code measurement or how much time has elapsed since a last available code measurement on the basis of a specific minimum number of satellites, for example at least four satellites.

A further possible signal quality indicator which can play a role when determining the signal integrity status by means of the assessment module using the lookup table is a point in time at which a correction service message was last generated or an age of corrections, that is to say a measured period of time that has elapsed between a correction service message generated last and the current system time (sample time) of the assessment module. Such correction service messages are known per se to a person skilled in the art in connection with GNSS-based highly accurate positioning. They usually comprise corrections for code and phase measurements, which are provided by commercial correction services, for example.

When determining the signal integrity status using the lookup table, a lateral and/or longitudinal speed of the vehicle and/or a lateral and/or longitudinal acceleration of the vehicle, for example, can also be used as additional possible signal quality indicators. In this case, these vehicle-dynamics variables may be provided by vehicle odometry, for example. Alternatively or additionally, speeds and/or accelerations may also be calculated on the basis of GNSS information.

In one example, the lookup table maps combinations of a plurality of ranges of the signal quality indicators, which are defined by the threshold values, to one nominal state of a number of nominal states. At least three different nominal states are preferably defined. In this case, the different combinations of signal quality indicators may define specific scenarios with regard to the availability and quality of GNSS signals for determining the position. For example, such scenarios may correspond, for instance, to an open-sky scenario, an urban scenario, a deep-urban scenario, etc. Alternatively, or additionally, other scenarios may also play a role, which scenarios each entail certain interfering influences for the GNSS signals, for example a journey in a tunnel or in the region of a sign gantry.

Provision may also be made for the lookup table to assign a signal integrity status from a number of defined signal integrity statuses to each of the nominal states. In this case, it is also possible for a plurality of different nominal states to be assigned to the same signal integrity status.

At least three different signal integrity statuses are preferably defined. In particular, at least the three signal integrity statuses “available and safe”, “available and unsafe” and “not available” (or the like), which accordingly characterize the usability of the GNSS signals as part of a specific driving assistance function, can preferably be defined.

The assignment between nominal states and signal integrity statuses may be respectively specifically defined on the basis of the driving assistance function under consideration. In other words, the lookup table may define different assignments for a plurality of different driving assistance functions, or different lookup tables with respective assignments may be stored for a plurality of different driving assistance functions.

At the data processing level, the assessment module may be configured to set a flag according to the respectively determined signal integrity status. This flag, which provides information relating to the usability of the currently available GNSS signals for a driving assistance function under consideration, at least approximately in real time, can then be taken into account when controlling the driving assistance function by means of the control module. For example, the control module can decide not to perform a safety-critical function or to perform it only to a limited extent if the assessment module has determined the signal integrity status “not available” or “available and unsafe”.

The control module may generally be configured to control the driving assistance function on the basis of the signal integrity status and (if available in sufficient quality) on the basis of the currently available GNSS signals themselves or variables derived therefrom, for example a vehicle position and/or a vehicle speed.

The control module may also be configured to use the currently available GNSS signals to control the driving assistance function on the basis of the signal integrity status by adaptively weighting an influence of the GNSS signals on the control of the driving assistance function on the basis of the signal integrity status of the currently available GNSS signals and/or on the basis of a nominal state assigned to the currently available GNSS signals. For example, in the case of the signal integrity status “available and unsafe”, provision may be made for the GNSS signals to indeed be taken into account for HD map localization within the driving assistance function, but to have a comparatively low weighting in comparison with other information sources, for example camera, radar or lidar information.

The control module may also be configured, in the event of degradation (that is to say deterioration) of the signal integrity status and/or in the event of degradation of the nominal state of the currently available GNSS signals, to accordingly degrade the driving assistance function. In this case, the driving assistance function can be degraded gradually, for example, with a gradual degradation of the signal integrity status and/or of the nominal state. In the event of a gradually deteriorating signal integrity status or nominal state, this may lead, for instance, from full functionality, via functionality that is restricted—possibly in a plurality of increments—to unavailability of the driving assistance function (and vice versa).

A second aspect of the present subject matter is a computer-implemented method for controlling a driving assistance function, comprising the steps of:
providing information relating to a quality of currently available GNSS signals;
using a lookup table to determine a signal integrity status of the currently available GNSS signals on the basis of the information provided, wherein the signal integrity status relates to the usability of the currently available GNSS signals for controlling the driving assistance function (and, for example according to a defined metric, indicates an availability, reliability and/or accuracy of the currently available GNSS signals with respect to the driving assistance function under consideration);
controlling the driving assistance function on the basis of the signal integrity status of the currently available GNSS signals (and possibly on the basis of the GNSS signals themselves or on the basis of variables derived therefrom) and/or using the currently available GNSS signals to control the driving assistance function on the basis of the signal integrity status.

The above-mentioned method steps may also be preceded by a step in which GNSS signals are received by means of a GNSS receiver module. The information relating to the quality of the currently available GNSS signals which is consequently provided can then be initially determined on the basis of these received GNSS signals.

The method according to the second aspect of the present subject matter can be carried out, in particular, by means of a system according to the first aspect of the present subject matter. Therefore, examples of the method according to the present subject matter can correspond to the advantageous examples of the system according to the present subject matter which are described above and below, and vice versa.

A third aspect of the present subject matter is software comprising instructions which, when the software is executed by a processing device, cause the latter to carry out a method according to the second aspect of the present subject matter. In this case, the software may also be divided into a plurality of separate subprograms which can each be executed on different processing devices (for example a plurality of processors) which are possibly spatially remote from one another.

For example, a system according to the first aspect of the present subject matter may comprise one or more processing apparatuses, on which software according to the third aspect of the present subject matter can be executed.

A fourth aspect of the present subject matter is a non-transitory computer-readable (storage) medium comprising instructions which, when executed by a (possibly distributed) processing device, cause the latter to carry out a method according to the second aspect of the present subject matter. In other words, software according to the third aspect of the present subject matter may be stored on the computer-readable (storage) medium.

A fifth aspect of the present subject matter is a vehicle having a system according to the first aspect of the present subject matter.

In accordance with the above, according to some examples of the present present subject matter, current boundary conditions with regard to available GNSS signals that are reflected in observables which can be captured by means of a GNSS receiver module are assigned to certain scenarios (nominal states). These are in turn mapped to a signal integrity status which represents an additional degree of confidence and security. This enables targeted and finely graduated consideration of the availability and quality of the GNSS signals when determining a position within a driving assistance function. Dynamic scenario-dependent degradation of the position information and possibly consequently also of the driving assistance function is also possible in particular. However, this need not necessarily be degradation. More generally, GNSS position information may be considered to a greater or lesser extent (in comparison with information provided by other sensors, for example) for the driving assistance function depending on the situation. In other words, the driving assistance function may possibly incorporate other sensor systems to a greater extent in the localization in order to avoid degradation caused by the insufficient GNSS position information, or vice versa. The driving assistance function may adaptively select the weighting of the use of the GNSS positioning solution on the basis of the respective scenario. The usability of the overall system and the availability of the driving assistance function can be increased by means of the finer modeling of the GNSS position determination solution.

In addition, the solution proposed here is particularly well suited to a product safety analysis according to SOTIF (Safety Of The Intended Functionality) since it enables a scenario-dependent safety analysis instead of a global worst-case consideration which would possibly result in an unnecessarily conservative design of the overall system. As a result, the proposed solution can thus contribute to also achieving and validating or verifying the demanding safety goals of a driving assistance system at SAE level 3 or higher. Furthermore, potential savings in other sensors can be made by the targeted, situation-dependent use of GNSS data.

The present subject matter is now explained in more detail on the basis of examples and with reference to the accompanying drawings. In this case, the features and combinations of features mentioned above or below in the description and/or shown in the drawings alone can be used not only in the respectively stated combination, but also in other combinations or alone, without departing from the scope of the present subject matter.

### BRIEF DESCRIPTION OF THE DRAWINGS

FIG. 1 illustrates, by way of example and schematically, a system for controlling a driving assistance function.

FIG. 2 shows a schematic flowchart of a method for controlling a driving assistance function.

FIG. 3 illustrates, by way of example and schematically, a lookup table for determining a signal integrity status of currently available GNSS signals.

### DETAILED DESCRIPTION OF THE DRAWINGS

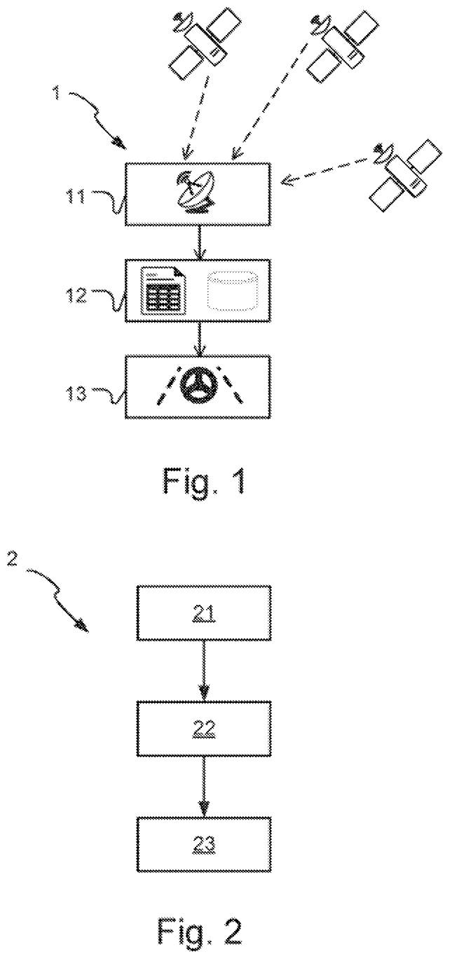

The example of a system 1 for controlling a driving assistance function, as illustrated in FIG. 1, is explained below, in which case reference is also immediately made to steps 21-23 of a corresponding method 2 which are illustrated in the form of a block diagram in FIG. 2.

The term module (and other similar terms such as unit, subunit, submodule, etc.) in the present disclosure may refer to a software module, a hardware module, or a combination thereof. Modules implemented by software are stored in memory or non-transitory computer-readable medium. The software modules, which include computer instructions or computer code, stored in the memory or medium can run on a processor or circuitry (e.g., ASIC, PLA, DSP, FPGA, or other integrated circuit) capable of executing computer instructions or computer code. A hardware module may be implemented using one or more processors or circuitry. A processor or circuitry can be used to implement one or more hardware modules. Each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices and stored in memory or non-transitory computer readable medium.

The system 1 comprises a GNSS receiver module 11, an assessment module 12 and a control module 12.

The GNSS receiver module 11 is configured to receive GNSS signals and to provide information relating to a quality of the currently available GNSS signals. This corresponds to method step 21 in FIG. 2: providing information relating to a quality of currently available GNSS signals.

The assessment module 12 is configured to use a lookup table to determine, on the basis of the information provided, a signal integrity status which relates to the usability of the currently available GNSS signals for controlling the driving assistance function. This corresponds to method step 22 in FIG. 2: determining a signal integrity status of the currently available GNSS signals on the basis of the information provided using a lookup table stored in a data memory of the assessment module 12, wherein the signal integrity status relates to the usability of the currently available GNSS signals for controlling the driving assistance function. In this case, a plurality of signal quality indicators contained in the information provided or derived therefrom are compared with respective threshold values stored in the lookup table in order to determine the signal integrity status.

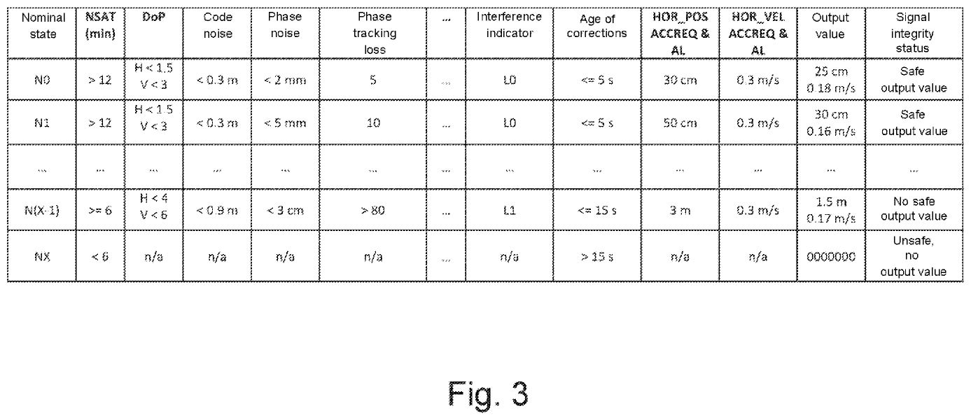

FIG. 3 shows, by way of example and schematically, such a lookup table for determining a signal integrity status of currently available GNSS signals. The signal quality indicators used in this example comprise, in particular, a number of currently available GNSS satellites “NSAT (min)”, a horizontal and/or vertical reduction in the accuracy “DoP” (separate threshold values for the horizontal DoP “H” and the vertical DoP “V” are indicated in the table), code noise, phase noise, a phase tracking loss, an interference indicator that indicates a degree of multipath interference and/or unintentional interference, and an age of corrections. In this case, the lookup table maps combinations of a plurality of ranges of the signal quality indicators mentioned, which are defined by the threshold values, to one of a number of nominal states N0, N1, . . . N(X−1), NX.

For example, the assessment module 12 would use the lookup table shown to determine the nominal state “N1” for the currently available GNSS signals if it determines, on the basis of the information provided by the GNSS receiver module, that 14 satellites are currently available, the horizontal DoP is 1.2, the vertical DoP is 2.0, the code noise is 0.2, the phase noise is 3 mm, the phase tracking loss is 10, the interference indicator is LO and the age of corrections is 2 seconds.

The lookup table also assigns a signal integrity status, which is indicated in the far right-hand column, to each of the nominal states. In this example, three possible signal integrity statuses are provided, specifically “safe output value”, “no safe output value” and “unsafe, no output value”.

The assignment between the nominal states (scenarios) N0, N1, . . . . N(X−1), NX and the signal integrity statuses “safe output value” or “no safe output value” is defined here on the basis of a specific driving assistance function according to its requirements in terms of the availability, accuracy and/or reliability of the GNSS signals. The lookup table can generally define different assignments for a plurality of different driving assistance functions, or different lookup tables with respective assignments can be stored for a plurality of different driving assistance functions.

The table in FIG. 3 indicates example accuracy requirements for a horizontal position determination (“HOR_POS ACCREQ & AL”) and for a horizontal speed determination (“HOR_VEL ACCREQ & AL”) which can each be met with a high level of availability or reliability (for example of at least 99%) by the available GNSS signals in a specific scenario NO, N1, . . . N(X−1) or NX. In this case, the accuracy requirements HOR_POS ACCREQ and HOR_VEL ACCREQ restrict an expected horizontal or vertical deviation, wherein the statement “AL” (for “Alarm Limit”) specifies even more accurately that this is the maximum permitted deviation which can be tolerated by the driving assistance function. In other words, in this example, the lookup table therefore also comprises a mapping of the signal quality indicators or the nominal states to corresponding position determination accuracies, which mapping can be taken into account when controlling the driving assistance function-via the resulting signal integrity status.

In the example constellation which was mentioned above and in which the nominal state/the scenario “N1” was determined, an output value of 30 cm assumed by way of example here for a horizontal vehicle position can be stated with an accuracy of +/−50 cm, and an output value of 0.18 m/s assumed by way of example here for a horizontal speed of the vehicle can be stated with an accuracy of +/−0.3 m/s. This information contained in the lookup table may be based, for example, on simulations and/or test drives which were carried out for the various scenarios. Based on the driving assistance function considered here, the accuracies mentioned suffice to obtain the signal integrity status “safe output value” that is indicated in the last column for the purposes of further processing by the control module.

The control module 13 is configured to control the driving assistance function on the basis of the signal integrity status of the currently available GNSS signals and/or to use the currently available GNSS signals to control the driving assistance function on the basis of the signal integrity status. This corresponds to method step 23 in FIG. 2: controlling the driving assistance function on the basis of the signal integrity status of the currently available GNSS signals and/or using the currently available GNSS signals to control the driving assistance function on the basis of the signal integrity status.

The control module may also be configured to use the currently available GNSS signals to control the driving assistance function on the basis of the signal integrity status by adaptively weighting an influence of the GNSS signals on the control of the driving assistance function on the basis of the signal integrity status of the currently available GNSS signals and/or on the basis of a nominal state assigned to the currently available GNSS signals. For example, in the case of the signal integrity status “available and unsafe”, provision may be made for the GNSS signals to indeed be considered for HD map localization within the driving assistance function, but to have a comparatively low weighting in comparison with other information sources, for example camera, radar or lidar information.

The control module may also be configured, in the event of degradation (that is to say deterioration) of the signal integrity status and/or in the event of degradation of the nominal state of the currently available GNSS signals, to degrade the driving assistance function. In this case, the degradation of the driving assistance function can be associated gradually, for example, with a gradual degradation of the nominal state and/or the signal integrity status. In the case of a gradually deteriorating nominal state (for example down to “NX”) or a gradually deteriorating signal integrity status (for example down to “unsafe, no output value”), this can lead from full functionality, via functionality that is restricted—possibly in a plurality of increments—to unavailability of the driving assistance function (and vice versa).

1.-11. (canceled)

12. A system for controlling a driving assistance function, comprising
a GNSS receiver module configured to:
receive GNSS signals, and
provide information relating to a quality of currently available GNSS signals;
an assessment module configured to use a lookup table to determine, based on the information provided, a signal integrity status which relates to the usability of the currently available GNSS signals for controlling the driving assistance function; and
a control module configured to control the driving assistance function based on the signal integrity status of the currently available GNSS signals.

13. The system according to claim 12, wherein the determination of the signal integrity status by means of the assessment module comprises:
comparing a plurality of signal quality indicators contained in the information provided and/or derived therefrom with respective threshold values stored in the lookup table.

14. The system according to claim 13, wherein the signal quality indicators comprise at least two of the following:
a number of currently available GNSS satellites;
a horizontal and/or vertical reduction in accuracy;
code noise;
phase noise;
a phase tracking loss; or
an interference indicator which indicates a degree of multipath interference and/or unintentional interference.

15. The system according to claim 13, wherein the lookup table:
maps combinations of a plurality of ranges of the signal quality indicators, which are defined by the threshold values, to one of a number of nominal states; and
assigns a signal integrity status to each of the nominal states.

16. The system according to claim 15, wherein the control module is further configured to:
weigh an influence of the GNSS signals when controlling the driving assistance function based on a nominal state assigned to the currently available GNSS signals.

17. The system according to claim 15, wherein the control module is further configured, during degradation of the nominal state of the currently available GNSS signals, to degrade the driving assistance function.

18. The system according to claim 12, wherein the control module is further configured to:
weigh an influence of the GNSS signals when controlling the driving assistance function based on the signal integrity status of the currently available GNSS signals.

19. The system according to claim 12, wherein the control module is further configured, during degradation of the signal integrity status of the currently available GNSS signals, to degrade the driving assistance function.

20. A computer-implemented method for controlling a driving assistance function, comprising
providing information relating to a quality of currently available GNSS signals;
using a lookup table to determine a signal integrity status of the currently available GNSS signals based on the information provided, wherein
the signal integrity status relates to the usability of the currently available GNSS signals for controlling the driving assistance function; and
controlling the driving assistance function based on the signal integrity status of the currently available GNSS signals.

21. A non-transitory computer-readable medium comprising instructions operable, when executed by one or more computing systems, to:
provide information relating to a quality of currently available GNSS signals;
use a lookup table to determine a signal integrity status of the currently available GNSS signals based on the information provided, wherein
the signal integrity status relates to the usability of the currently available GNSS signals for controlling the driving assistance function; and
control the driving assistance function based on the signal integrity status of the currently available GNSS signals.
